(19) United States
(12) Patent Application Publication
(10) Pub. No.: US 2002/0154973 A1
(43) Pub. Date: Oct. 24, 2002

(54) Automated side loader

(76) Inventors: Steve Bradshaw, Irvine, CA (US); Ricky Martinez, Baldwin Park, CA (US); Phillip Sweet, Fresno, CA (US)

Correspondence Address: N. THANE BAUZ, Fish & Richardson P.C., 4350 La Jolla Village Drive, Suite 500, San Diego, CA, 92122, US

(21) Appl. No.: 09/837,908

(22) Filed: Apr. 18, 2001

(51) Int. Cl. B65F 3/02

(52) U.S. Cl. 414/408

(57) ABSTRACT

An automated side loader including an automated arm, lateral extension arm, and waste container latching mechanism all attached to the chassis of the vehicle via a lateral extension arm housing and support brackets and includes a swing arm, disposed between the lateral extension arm and the waste container latching mechanism, and a central plate wherein the central plate and swing arm arrangement reduces the stress associated with lifting heavy waste containers and reduces the amount of whip associated with rapidly lifting the waste container along a curvilinear path.

### TECHNICAL FIELD

This invention relates generally to an automated side loader for refuse collection, and more particularly to an extendable and rotatable automated side loader.

### BACKGROUND

Garbage or refuse in populated areas has long been deposited into containers for manual collection by waste haulers. Typically, the refuse containers are picked up by waste collection personnel in refuse collection vehicles equipped with compactors. The refuse collection vehicles have loading apparatus for lifting the waste containers from the street and dumping them into the waste hauling vehicles for compacting and disposal.

Municipalities and waste management service companies have begun to utilize a number of automated refuse collection devices. One configuration involves a vehicle with an automated side loader. In this configuration, the driver of the vehicle can remotely operate a side-mounted swing arm that extends outwardly from the vehicle, grasps the waste container, and lifts it into a position where the waste or refuse contained therein can be dumped into the hopper portion of the vehicle.

An automated side loader can have structural and stability problems associated with cantilevered lifting of the waste container. It is advantageous to rapidly move the waste container. Rapidly moving heavy waste containers along a curvilinear path can result in stress cracks in the structural members and undesirable whip action when the load is being lifted and dumped. The whip action increases stress throughout the side loader structure and decreases stability. Moreover, as waste containers increase in size, problems with stability and structural integrity increase. The adverse affects of rapidly moving the cantilevered load become more pronounced.

### SUMMARY

It is therefore an object of the invention to provide an improved automated side loader for collecting waste contained in garbage cans, refuse containers or other types of waste containers. It is an object of the present invention to also provide an automated side loader that maximizes the amount of waste that can be lifted and dumped into the vehicle hopper. It is another object of the invention to decrease the weight of the automated side loader design by optimizing stress distribution throughout the automated side loader. It is a further object of the invention to reduce the whip effect associated with rapidly moving a cantilevered load. In this case, moving the waste container from an upright position and rapidly lifting it until it is rotated more than 90 degrees so that the waste falls out of the container and into the hopper section of the vehicle while minimizing whip effects.

The foregoing objects of the present invention are obtained by an automated side loader including an automated arm, a waste container receptacle, a lateral extension arm, a spindle between the automated arm and lateral extension arm, a waste container latching mechanism, and support brackets for securing the lateral extension arm housing to the vehicle. The vehicle is mobile and typically includes a cab, a chassis, and a hopper for holding and compacting the waste. The chassis can be a truck body, which is joined to a hopper as part of a single integrated unit. However, a wide range of vehicle sizes and shapes is envisioned.

In one embodiment, the vehicle is a truck that has a cab and a hopper attached to the chassis. The automated side loader includes an automated arm, lateral extension arm, and waste container latching mechanism. These components are all attached to the chassis of the vehicle via a lateral extension arm housing and support brackets. The automated arm includes a swing arm, disposed between the lateral extension arm and the waste container latching mechanism, and a central plate. The central plate and swing arm configuration reduces the stress associated with lifting heavy waste containers and decrease the amount of whip associated with lifting the waste container along a curvilinear path. Other objects, features and advantages of the present invention will become apparent to those skilled in the art through familiarity with the summary of the invention, detailed description, claims and drawings herein.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front view of a vehicle equipped with an automated side loader that is depicted in a fully extended position with the waste container in the waste container latching mechanism.

FIG. 2 is a side view of the automated arm portion of the side loader.

FIG. 3 is a front view of the central plate.

FIG. 4 is a top view of the automated arm.

FIG. 5 is a side view of the automated arm.

FIG. 6 is a graph demonstrating the translation of a waste container during the operation of the automated arm invention.

Like reference symbols in the various drawings indicate like elements.

### DETAILED DESCRIPTION

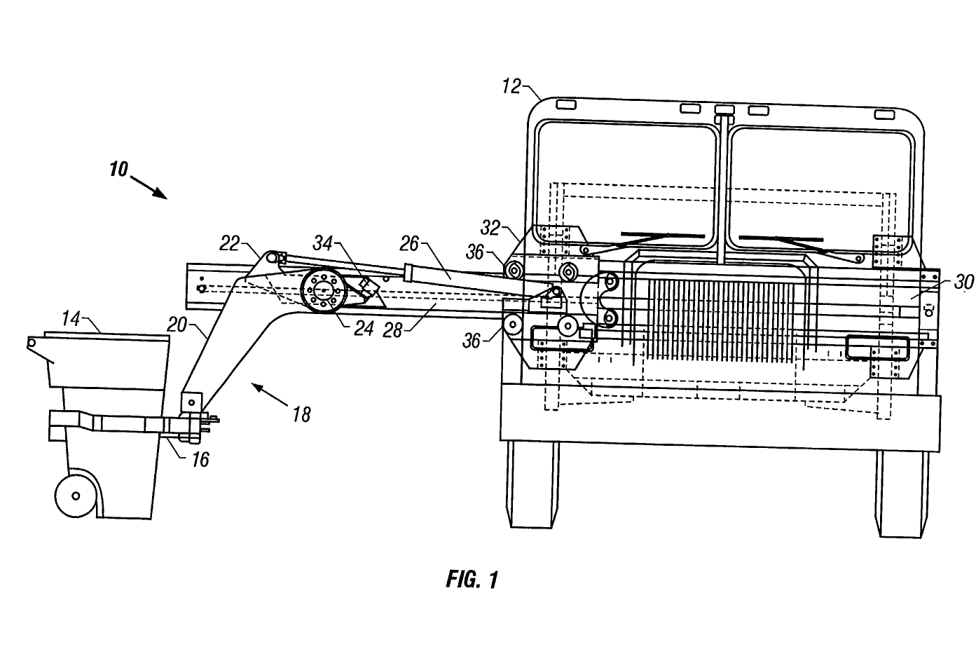

Referring to FIG. 1, a vehicle 12 is depicted with lateral extension arm 28, automated arm 18, waste container latching mechanism 16, with a waste container 14. Many different types of vehicles 12 can be utilized, including large and small diesel-powered trucks. Likewise, the container 14 can come in a variety of sizes and shapes resulting in loads on the automated arm exceeding 1,200 lbs.

The lateral extension arm 28 moves in a general horizontal direction because it is slideably mounted on lateral extension arm housing 30 (not shown). The lateral extension arm 28 is slideably mounted through the use of rollers 36 located on both the lateral extension arm 28 and the lateral extension arm housing 30. Other arrangements for slideably mounting the lateral extension arm 28 to the lateral extension arm housing 30 are well known to those with skill in the art. The lateral extension arm 28 can move outward from the vehicle 12 so that the automated arm 18 and waste container latching mechanism 16 can be extended to reach the waste container 14. The lateral extension arm 28 is mechanically actuated typically with one or more well known hydraulic cylinders (not shown). Other well known actuators can be utilized.

The automated side loader 10 operation can be demonstrated by reference to FIG. 1. The vehicle 12 can be moved until the vehicle 12 is along side the waste container 14. Thereafter, the operator of the vehicle can move control switches (not shown) that result in the lateral extension arm 28 slideably moving away from the vehicle 12 via rollers 36 and toward the waste container 14. Thereafter, the waste container latching mechanism 16 can secure the waste container 14 through the use of any well known actuator, for example, hydraulic cylinders (not shown). Once secured, the operator of the vehicle can move control switches (not shown) that cause the hydraulic cylinder 26 to retract. By virtue of the fact that the central plate 22 and swing arm 20 are secured, retraction of the hydraulic cylinder 26 results in the swing arm 20, the central plate 22 and the waste container latching mechanism 14 being rotated about the axis of the spindle 24. The waste container 14 can be rotated about the spindle 24 until the swing arm 22 makes contact with the stop block 34. As a result, the waste container 14 is lifted up and rotated more than 90 degrees until the contents therein fall into the hopper section (not shown) of the vehicle 12.

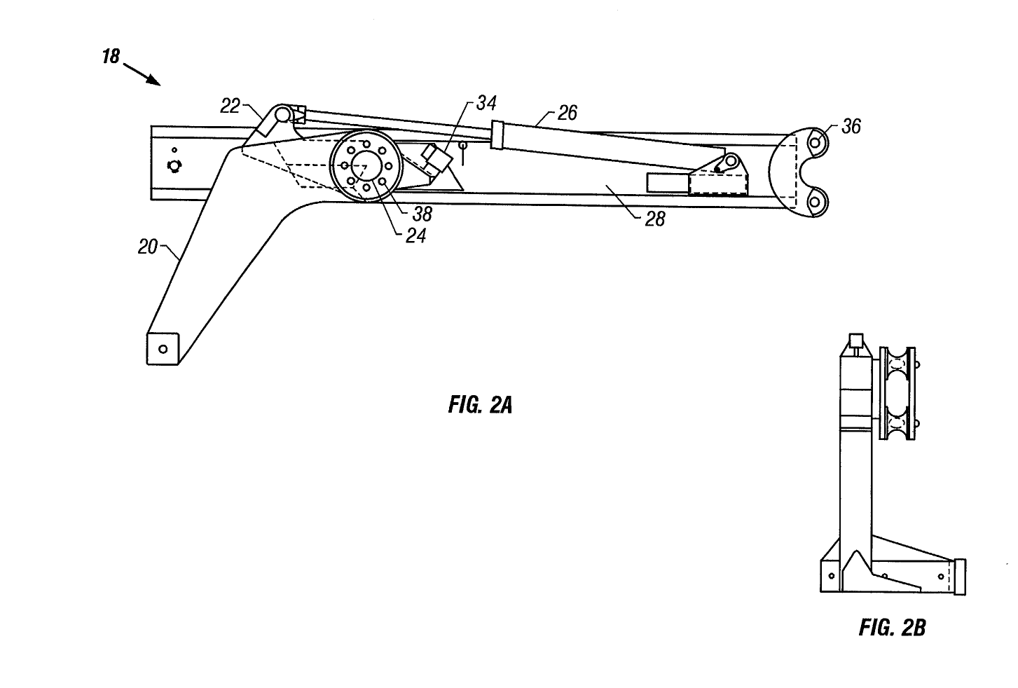

Referring to FIG. 2, the automated arm 18 includes lateral extension arm 28, hydraulic cylinder 26, central plate 22, spindle 24 and swing arm 20. Swing arm 20 is pivotally attached to lateral extension arm 28 by spindle 24. The spindle 24 must be able to withstand heavy loads and smoothly and efficiently rotate the swing arm 20 about the lateral extension arm 28. Those with skill in the art will appreciate many ways to implement the spindle 24, including the use of a hub and wheel often used in conjunction in the presence of heavy radial and thrust loads. The hub and wheel arrangement can include tapered-roller bearings and associated well known components for withstanding the radial and thrust loading conditions present when the swing arm 20 rapidly moves about the spindle 24 with the load associated with waste container 14.

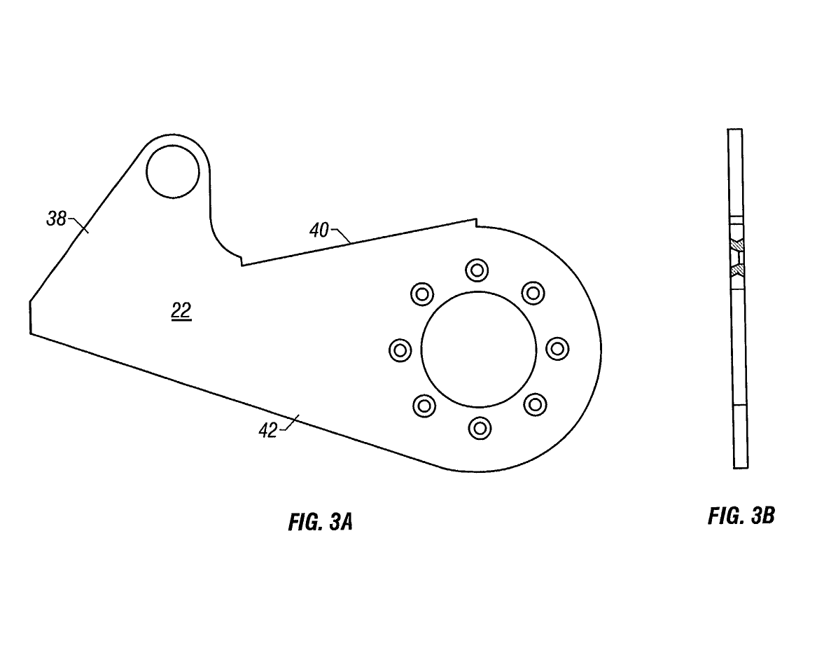

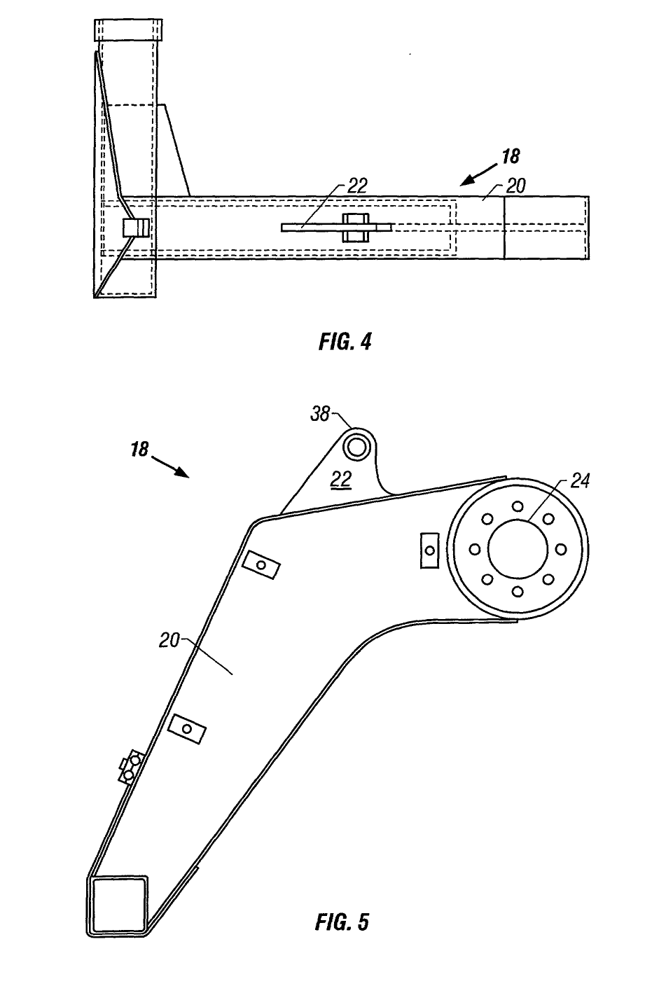

The spindle 24 can rotate and is attached to the central plate 22 by use of a series of bolts 38. Other means can be used to attach the central plate 22 to the spindle 24. For example, the central plate 22 can be welded to the spindle 24 so that the central plate 22 rotates freely about the lateral extension arm 28 by use of bearings (not shown) in the spindle 24. The central plate 22 is fixed to the swing arm 20 in such a manner as to reduce the stress associated with the hydraulic cylinder 26. As depicted in FIG. 3, the central plate 22 has an upper portion 38, a leading edge 40 for engaging the swing arm 20, and a lower portion 42. As depicted in FIGS. 4 and 5, the upper portion 38 protrudes through an opening in the swing arm 20 for attaching to a hydraulic cylinder or other similar actuator device. Referring again to FIG. 3, the leading edge 40 has a contour that preferably matches the contour of the swing arm 20. In this way, the leading edge 40 can engage the swing arm 20. For example, as depicted in FIG. 2, the central plate 22 is fixed to the swing arm 20 so that when the hydraulic cylinder 26 is actuated and the waste container 14 is moved, the central plate 22 and swing arm 20 will rotate together about the spindle 24.

The leading edge 40 is substantially flat and long and therefore the leading edge 40 can distribute the stress associated with lifting the waste receptacle 14 throughout the longitudinal length of the swing arm 20. The leading edge 40 can have a number of shapes and sizes, as long as it is in contact with the swing arm 20 in such a manner so stress is substantially distributed across the swing arm 20. This helps prevent structural wear that would otherwise occur if the hydraulic cylinder 26 were directly connected to the swing arm 20.

The dimensions of the central plate 22 must be sufficient to withstand the stress associated with the lifting of the waste receptacle 14, which can exceed 500 pounds. Additionally, the dimensions of the central plate must be sufficient to distribute the stress through the swing arm 20. The dimensions can be accounted for by accurately estimating the design load associated with the waste receptacle 14 and the size and shape of the automated arm 18.

The lower portion 42 of the central plate 22 is fixed to the spindle 24. The lower portion 42 of the central plate 22 must be large enough to withstand the stresses associated with lifting waste receptacle 14. Although a variety of shapes and sizes can be utilized, the distance between the upper portion 40 and the lower portion 42 preferably should have a length, nearest to the spindle 24, roughly twice the diameter of the opening for the spindle 24 or greater. Likewise, those of skill in the art will appreciate that the leading edge 40 of the central plate 22 can have a variety of sizes and shapes. The longitudinal length of the leading edge 40 preferably can be greater than thirty percent of the longitudinal length of the central plate 22. Thus, the central plate 22 thoroughly distributes stress through the swing arm 20. These dimensions and the shapes, however, can vary greatly depending on weight of the design load associated with the waste receptacle 14 as well as the dimension of the automated arm 18 without departing from the spirit and letter of the invention.

As shown in FIG. 3, the upper portion 38 of the central plate 22 is preferably disposed above the leading edge 40. Likewise, the upper portion 38 is also preferably disposed above the spindle 24 as depicted in FIG. 5. As depicted in FIG. 2, this arrangement advantageously results in an incline from horizontal of the hydraulic cylinder 26. When the waste receptacle 14 is lifted, the stress is more thoroughly distributed in the central plate 22 because the initial stress is distributed in both a vertical and horizontal direction through the central plate 22 and swing arm 20. In contrast, if the hydraulic cylinder 26 is not inclined, stress is undesirably maximized in a horizontal direction on the central plate 22. This can result in stress cracks and undesirable wear.

Whip occurs when the lift per inch of the beginning of the stroke of the hydraulic cylinder 26 is too low. This condition creates a jerking motion that decreases stability and increases stress in the automated side loader 10 when the waste container 14 is lifted. Likewise, whip can occur when the lift per inch of the end of the stroke of the hydraulic cylinder 26 is too low. As a result, a jerking motion is created when the waste is dumped from the waste container 14 into the hopper section of the vehicle 12. Whip increases stress and decreases stability and is undesirable.

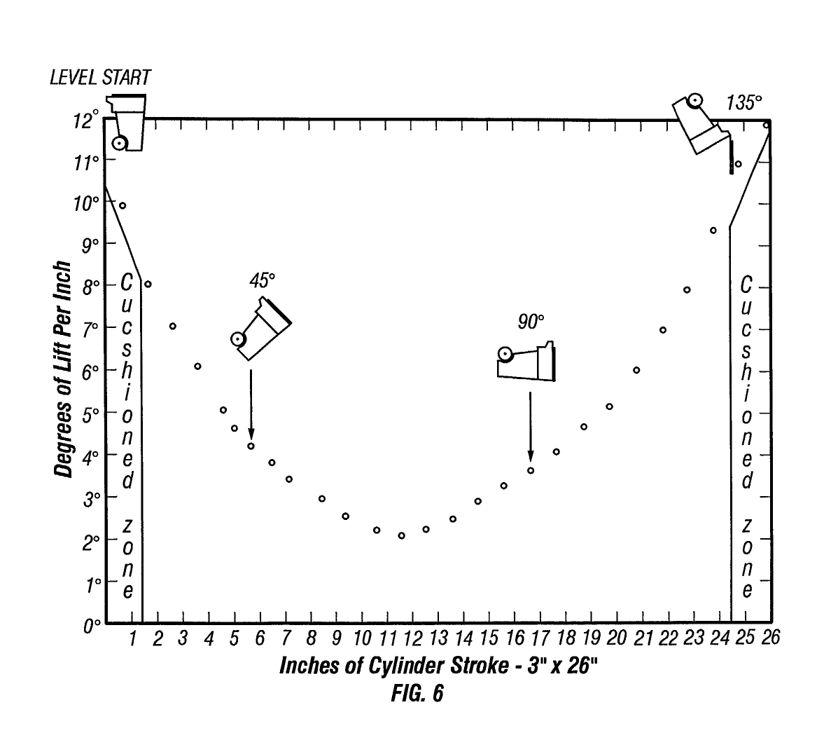

FIG. 6 is an example of the anti-whip feature of the invention, which improves both stress and stability conditions in the automated side loader 10. The anti-whip feature is achieved by the geometric relationship of the central plate 22, the spindle 24 and the hydraulic cylinder 26. This relationship, as depicted by way of the example in FIG. 1, means that the beginning stroke and ending stroke of the hydraulic cylinder 26 has a cushioned zone, i.e., the waste container 14 will experience a high degree of lift per inch stroke of the hydraulic cylinder 26. In other words, the hydraulic cylinder 26 will be experiencing greater degree of vertical translation at the beginning and ending of the stroke of the hydraulic cylinder 26 thereby minimizing whip affects associated with curvilinear movement of the waste container 26.

In contrast, as depicted in FIG. 6, during the middle of the hydraulic cylinder 26 stroke, there is a substantially lesser degrees of lift. This means that the waste container 26 is experiencing a larger degree of horizontal translation. A smoother motion results from the anti-whip geometry of the invention. Other geometries are contemplated where the cushioned zones are achieved during the translation of the waste container 14.

A number of embodiments of the invention have been described. Nevertheless, it will be understood that various modifications may be made without departing from the spirit and scope of the invention. For example, several central plates 22 can be utilized within the swing arm 20. Likewise, several hydraulic cylinders 26 or other well known actuators can be utilized. Moreover, the shape of the central plate 22 can vary. The leading edge 40, for example, can have a shape that maximizes contact with the swing arm 20. Additionally, the central plate can have several upper portions 38. Accordingly, other embodiments are within the scope of the following claims.

What is claimed is:

1. An automated side loader for mounting on a vehicle for collecting waste from a waste container comprising:
a lateral extension arm housing secured to the frame of said vehicle;
a lateral extension arm slideably mounted in said lateral extension arm;
an actuator for extending said lateral extension arm away from said vehicle and retracting said lateral extension arm toward said vehicle;
a waste container latching mechanism for securing said waste container;
an automated arm disposed between said lateral extension arm and said waste container latching mechanism, said automated arm secured to said waste container latching mechanism and to said lateral extension arm, said automated arm comprising:
a swing arm;
a spindle connecting said swing arm to said lateral extension arm and allowing said swing arm to rotate about said lateral extension arm;
a central plate having an upper portion and lower portion, said upper portion above said swing arm, said lower portion secured to said spindle, said central plate secured to said swing arm; and
a second actuator having a first end and a second end, said first end secured to said upper portion of said central plate and said second end secured to said lateral extension arm.

2. An automated side loader as recited in claim 1, wherein said secured actuator comprises a hydraulic cylinder, said hydraulic cylinder is vertically higher at said first end than said second end thereby resulting in a higher degree of lift of said waste container at the beginning and the ending of the stoke of said hydraulic cylinder.

3. An automated side loader as recited in claim 1, wherein said central plate height nearest to said spindle is greater than the diameter of the opening of said spindle.

4. An automated side loader as recited in claim 1, wherein said central plate has a leading edge, said leading edge disposed to make contact with said swing arm, said leading edge having a length greater than thirty percent of the length of said swing arm.

5. An automated side loader as recited in claim 1, wherein said actuator means comprises a hydraulic cylinder.

6. An automated arm having a waste container latching mechanism for grabbing waste containers, said automated arm comprising:
a spindle;
a swing arm pivotally mounted to said spindle;
a central plate having an upper portion and lower portion, said upper portion above said swing arm, said lower portion secured to said spindle, said central plate secured to said swing arm; and
an actuator having a first end and a second end, said first end fixed to said upper portion of said central plate.

7. An automated side loader as recited in claim 6, wherein that second end of said actuator is fixed at a point vertically below said first end.

8. An automated side loader as recited in claim 6, wherein said central plate height nearest to said spindle is greater than the diameter of the opening of said spindle.

9. An automated side loader as recited in claim 6, wherein said central plate height nearest to said spindle is greater than twice the diameter of the opening of said spindle.

10. An automated side loader for mounting on a vehicle for collecting waste from a waste container comprising:
a lateral extension arm housing secured to the frame of said vehicle;
a lateral extension arm slideably mounted in said lateral extension arm;
an actuator for extending said lateral extension arm away from said vehicle and retracting said lateral extension arm toward said vehicle;
a waste container latching mechanism for securing said waste container;
an automated arm disposed between said lateral extension arm in said waste container latching mechanism, said automated arm secured to said waste container latching mechanism and to said lateral extension arm, said automated arm comprising:
a swing arm;
a spindle connecting said swing arm to said lateral extension arm and allowing said swing arm to rotate about said lateral extension arm;
a central plate having an upper portion and lower portion, said upper portion above said swing arm, said lower portion secured to said spindle, said central plate secured to said swing arm and having a leading edge disposed to make contact with said swing arm, said leading edge having a length greater than thirty percent of said swing arm; and
a second actuator having a first end and a second end, said first end secured to said upper portion of said central plate and said second end secured vertically below said first end.
